(19) United States
(12) Patent Application Publication
(10) Pub. No.: US 2013/0067959 A1
(43) Pub. Date: Mar. 21, 2013

(54) A GRAPHITE CRUCIBLE FOR SILICON ELECTROMAGNETIC INDUCTION HEATING AND APPARATUS FOR SILICON MELTING AND REFINING USING THE GRAPHITE CRUCIBLE

(71) Applicants: Jin Seok Lee, Daejeon (KR); Young Soo Ahn, Daejeon (KR); Bo Yun Jang, Daejeon (KR); Joon Soo Kim, Daejeon (KR)

(72) Inventors: Jin Seok Lee, Daejeon (KR); Young Soo Ahn, Daejeon (KR); Bo Yun Jang, Daejeon (KR); Joon Soo Kim, Daejeon (KR)

(73) Assignee: Korea Institute of Energy Research, Daejeon (KR)

(21) Appl. No.: 13/677,334

(22) Filed: Nov. 15, 2012

Related U.S. Application Data
(63) Continuation-in-part of application No. 12/568,436, filed on Sep. 28, 2009.

(30) Foreign Application Priority Data
Oct. 16, 2008 (KR) 10-2008-0101658

(51) Int. Cl. F27B 14/06; F27B 14/00

(52) U.S. Cl. CPC F27B 14/061; F27B 14/00
USPC 65/355; 65/374.15

(57) ABSTRACT

The present disclosure provides a graphite crucible induction-based silicon melting. The graphite crucible comprises a cylindrical body having a plurality of slits which is formed through an outer wall and an inner wall of the cylindrical body and a bottom part connected with an edge of the cylindrical body to seal an end of the cylindrical body.

### CROSS-REFERENCE TO RELATED APPLICATIONS

This application is a continuation-in-part of U.S. patent application Ser. No. 12/568,436, filed on Sep. 28, 2009, which claims priority under 35 USC 119 from Korean Patent Application No. 10-2008-0101658, filed on Oct. 16, 2008, all of which are hereby incorporated by reference for all purposes as if fully set forth herein.

### FIELD OF THE INVENTION

The present invention relates to a crucible for silicon melting and, more particularly, to a graphite crucible for electromagnetic induction-based silicon melting, which can melt semiconductors such as silicon with high efficiency by a combination of crucible-heat indirect melting and electromagnetic induction-based direct melting, and an apparatus for melting and refining silicon using the same.

### BACKGROUND OF THE INVENTION

Electromagnetic induction-based direct melting can rapidly melt metallic materials, thereby ensuring high yield with minimized contamination of raw materials. Electromagnetic induction-based direct melting is generally performed according to the following principle.

When an alternating current is applied to an induction coil wound around a crucible to induce magnetic field variation, an induction current is created on the surface of metal to be melted thereby inducing Joule heating, which melts the metal. Further, the induction current interacts with a magnetic field to generate Lorentz force in the molten metal.

Since the Lorentz force is always directed toward an inner center of the crucible and provides a pinch effect or electromagnetic pressure effect according to the Fleming's left hand rule even when the direction of the current in the coil is varied, it is possible to prevent the molten metal from contacting an inner wall of the crucible.

However, the electromagnetic induction melting cannot be applied when melting semiconductors such as silicon. That is, since silicon has a very high melting point of 1,4000° C. or more and a very low electric conductivity at 700° C. or less unlike metals, it is difficult to achieve direct electromagnetic induction-based silicon melting.

When melting semiconductors such as silicon, indirect melting with heat from a graphite crucible is generally used. Although graphite is a non-metallic material, it has very high electric and thermal conductivity, thereby allowing the crucible to be easily heated through electromagnetic induction.

As known in the art, however, since graphite in the crucible shields electromagnetic waves, an electromagnetic force cannot be delivered to the graphite crucible. Thus, currently, melting the semiconductors such as silicon in the graphite crucible is carried out only by indirect melting with heat from the crucible.

When indirect silicon melting is performed in the graphite crucible, silicon melt contacts the surface of the crucible. Then, the silicon melt reacts with graphite, thereby causing carbon contamination on silicon from the inner surface of the crucible. Furthermore, the reaction between the silicon melt and 5 graphite generates a silicon carbide layer on the inner surface of the crucible, which often causes cleavage of the crucible.

To solve such problems, a technique for silicon carbide (SiC) coating or high density treatment on an inner surface of a graphite crucible which will contact silicon is proposed.

FIG. 1 shows a cross-section of the graphite crucible, an inner surface of which is coated with SiC.

In FIG. 1, a silicon carbide coating 110 is formed on the inner surface of the graphite crucible and suppresses reaction between graphite and silicon melt.

As a result, it is possible to prevent contamination of silicon or the crucible. Furthermore, the suppression of the reaction can prevent thickness growth of a composite layer 120, which has silicon carbide dispersed in a graphite matrix of the composite layer 120, into a graphite base 130, thereby preventing cleavage of the graphite crucible.

However, the SiC coating 110 tends to be exfoliated from the inner surface of the crucible while melting silicon in the crucible, thereby reducing lifespan of the crucible and insufficiently preventing contamination of silicon.

A cold copper crucible can be used to prevent contact between the silicon melt and the inner surface of the crucible during silicon melting. However, although it has a merit of preventing contact between the silicon melt and the crucible by electromagnetic induction, this crucible requires an assistant heat source for forming an initial silicon melt and generally undergoes severe heat loss due to cooling water.

To solve the problems of the cold copper crucible, a technique of using plasma as an assistant heat source is proposed. However, this technique complicates structure of a silicon melting apparatus and provides low efficiency due to heat loss of 30% or more through cold copper crucible.

To solve the problems of the graphite crucible and the cold copper crucible, a crucible which combines the structure of the cold copper crucible (cold crucible) and the graphite crucible (hot crucible) is proposed. The structure of this crucible is shown in FIG. 2.

In FIG. 2, the disclosed crucible includes a hot crucible 250 formed of a graphite material and disposed on top of a cold copper crucible 220. The hot crucible 20 250 has a circumferentially integral upper end and plural segments 240 are formed from a lower end of the hot crucible 250 to a lower end of the cold crucible 220 by a plurality of vertical slits 230. The hot crucible 250 is insulated by an insulator 260 to improve silicon heating efficiency and to protect an induction coil 210.

In the crucible of this configuration, after forming an initial silicon melt using the hot graphite crucible 250, a raw material of the initial silicon melt is further heated and melted, with electromagnetic pressure longitudinally exerted to the overall silicon melt and maintained above the hydrostatic pressure of the silicon melt, thereby improving heating and melting efficiency.

Since the disclosed crucible is formed by combining the cold crucible and the hot crucible, it is more difficult to fabricate such a combination type crucible than an integral type crucible such as the graphite crucible and the like. Moreover, as shown in FIG. 2, since the upper hot crucible formed of the graphite material serves only as the assistant heat source and silicon melting is performed substantially by the cold crucible, the crucible inevitably undergoes heat loss due to water cooling.

### SUMMARY OF THE INVENTION

An aspect of the present invention is to provide a highly efficient graphite crucible for electromagnetic induction-based silicon melting and an apparatus for melting and refining silicon using the same, which can solve problems caused by contact between a silicon melt and graphite in a typical graphite crucible and can solve a problem of heat loss caused by water cooling in a typical cold copper crucible.

In accordance with another aspect of the present invention, an apparatus an apparatus for melting and refining silicon with a crucible for electromagnetic induction-based silicon melting, the apparatus comprises a graphite crucible charged with a silicon raw material and an induction coil surrounding the graphite crucible, wherein the graphite crucible includes a plurality of slits formed through an outer wall and an inner wall thereof so that a silicon melt which the silicon raw material is melted by undergoing induction heating of the induction coil does not react with an inner wall the graphite crucible.

The graphite crucible comprises a cylindrical body having a plurality of slits which is formed through an outer wall and an inner wall of the cylindrical body; and a bottom part connected with an edge of the cylindrical body to seal an end of the cylindrical body.

The plurality of slits may be formed from an upper side of the cylindrical body to a bottom side of the cylindrical body and separated at constant intervals from each other.

An inner surface of the bottom part may be coated with at least one of SiC and Si3N4.

The bottom part may comprise a plurality of auxiliary slits which are formed from an edge portion of the bottom part toward a center portion of the bottom part.

The plurality of auxiliary slits may be not formed at a center of the bottom part so that the plurality of auxiliary slits are disconnected each other on the bottom part.

The plurality of auxiliary slits may be correspondingly connected to the plurality of slits.

The plurality of auxiliary slits may distribute an eddy current which is created by an electromagnetic force of the induction coil.

In accordance with another aspect of the present invention, an apparatus for melting and refining silicon with a crucible for electromagnetic induction-based silicon melting, the apparatus comprises a graphite crucible charged with a silicon raw material and an induction coil surrounding the graphite crucible, wherein the graphite crucible includes a plurality of slits formed through an outer wall and an inner wall thereof so that an electromagnetic force which is created by the induction coil effects toward an inner portion of the graphite crucible.

According to an embodiment of the invention, the graphite crucible can be fabricated at low cost and solve problems of contact between a silicon melt and graphite and heat loss by a combination of indirect melting and contact-free electromagnetic induction-based direct melting, thereby achieving highly efficient electromagnetic induction-based silicon melting and high purity refining by agitation of the silicon melt.

### BRIEF DESCRIPTION OF DRAWINGS

FIG. 1 shows a cross-section of a conventional graphite crucible coated with silicon carbide.

FIG. 2 is a sectional view of a conventional crucible which includes an upper hot crucible disposed on top of a cold crucible.

FIG. 3 is a view of a graphite crucible for electromagnetic induction-based silicon melting according to an embodiment of the present invention.

FIG. 4 is a perspective view of the graphite crucible shown in FIG. 3.

FIGS. 5 and 6 are results of numerical analysis on interior magnetic field density of a conventional cold copper crucible and a graphite crucible according to an example of the present invention, respectively.

FIG. 7 is a graph depicting hydrostatic pressure and electromagnetic pressure acting on a silicon melt in the vertical direction within the graphite crucible according to the embodiment of the present invention.

FIG. 8 is a graph depicting temperature of a crucible bottom, an upper side of a slit, and an upper surface of silicon when melting silicon using the graphite crucible according to the embodiment of the present invention.

FIG. 9 is a picture of solid silicon obtained using the graphite crucible according to the embodiment of the present invention.

FIG. 10 is a perspective view of a graphite crucible for electromagnetic induction-based silicon melting according to another embodiment of the present invention.

FIG. 11 is a graph depicting a result of numerical analysis on electromagnetic pressure acting on silicon melt in a graphite crucible including second slits on the bottom thereof according to an example of the present invention.

FIG. 12 shows an example of the second slits formed on the bottom of the graphite crucible shown in FIG. 10.

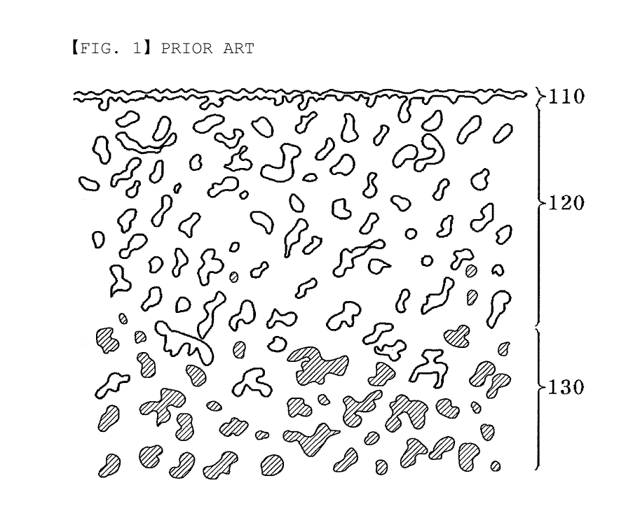

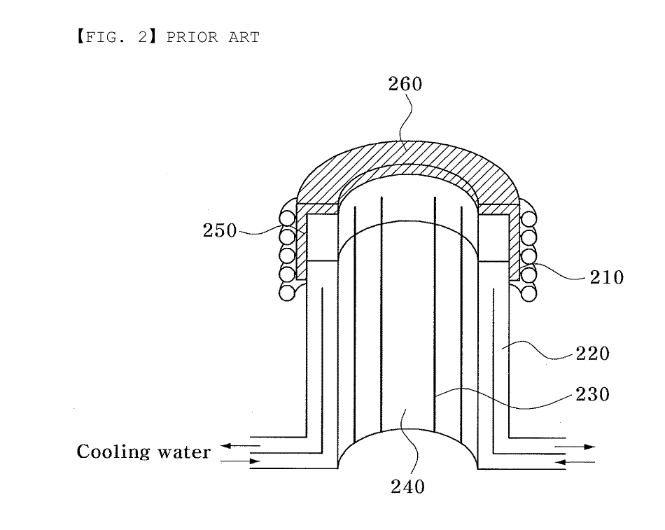

### DETAILED DESCRIPTION OF THE INVENTION

Embodiments of the present invention will now be described with reference to the accompanying drawings.

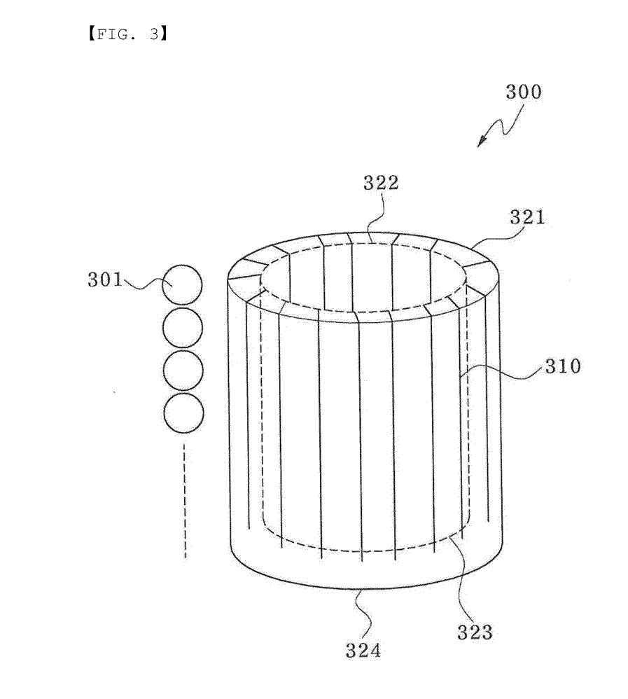

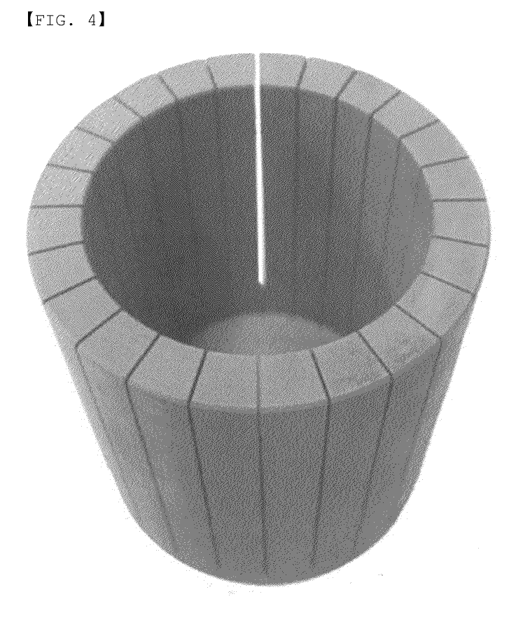

FIG. 3 is a view of a graphite crucible for electromagnetic induction-based silicon melting according to an embodiment of the present invention. FIG. 4 is a picture of the graphite crucible shown in FIG. 3. FIG. 4 will also be referred to in description of the graphite crucible of FIG. 3.

In FIG. 3, the graphite crucible 300 according to the embodiment includes a cylindrical body which has an open upper part. An outer wall 321 of the crucible is surrounded by an induction coil 301 during a process of melting silicon. A silicon raw material is charged into the crucible through the upper part of the crucible.

As shown in FIG. 4, the graphite crucible 300 has a plurality of slits 310 vertically formed through an inner wall 322 and the outer wall 321 of the crucible. In typical silicon melting graphite crucibles which have no slit, an electromagnetic force does not substantially act within the crucible because electromagnetic waves are shielded by graphite.

On the contrary, in the crucible having the plural slits 310 penetrating the inner and outer walls 322 and 321 of the crucible as shown in FIG. 3, the electromagnetic waves are not shielded by graphite so that the electromagnetic force can be intensively exerted into the crucible, as can be seen from test results described below.

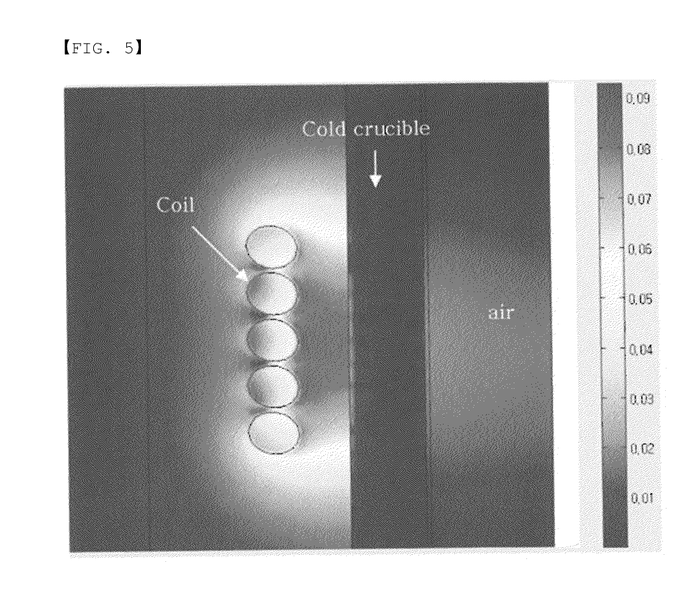

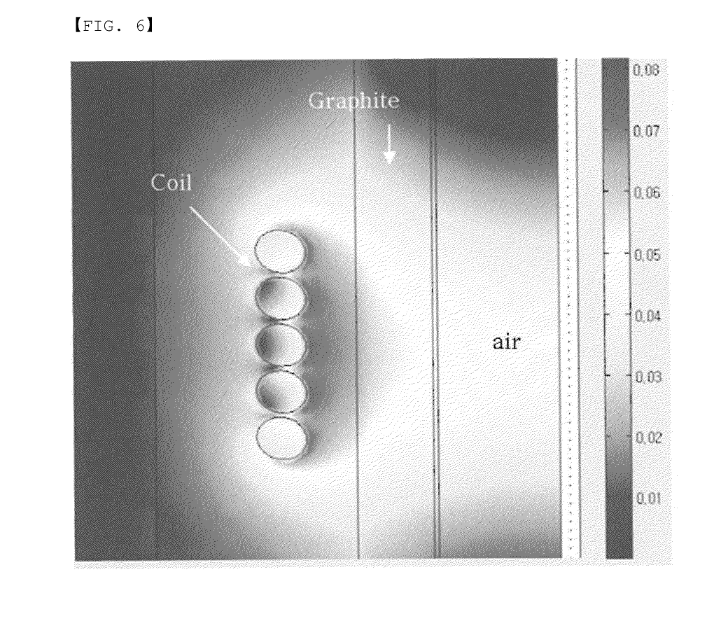

FIGS. 5 and 6 show results of numerical analysis on interior magnetic field density of a conventional cold copper crucible and a graphite crucible according to an example of the present invention, respectively.

It can be seen from FIGS. 5 and 6 that the graphite crucible having plural slits (FIG. 6) has a higher interior magnetic field density than the conventional cold copper crucible (FIG. 5). This means that the plural slits formed in the graphite crucible enable the electromagnetic force to be further intensively exerted toward the inner center of the crucible.

Therefore, the electromagnetic force created by an electric current flowing in the induction coil 301 acts toward the inner center of the crucible and prevents silicon melt from contacting the inner wall 322 of the crucible.

Even when the electromagnetic force is exerted toward the inner center of the crucible, if the electromagnetic force is less than a hydrostatic pressure caused by gravity, the silicon melt will spread. Thus, the electromagnetic force must be higher than the hydrostatic pressure in the direction of the inner center of the crucible.

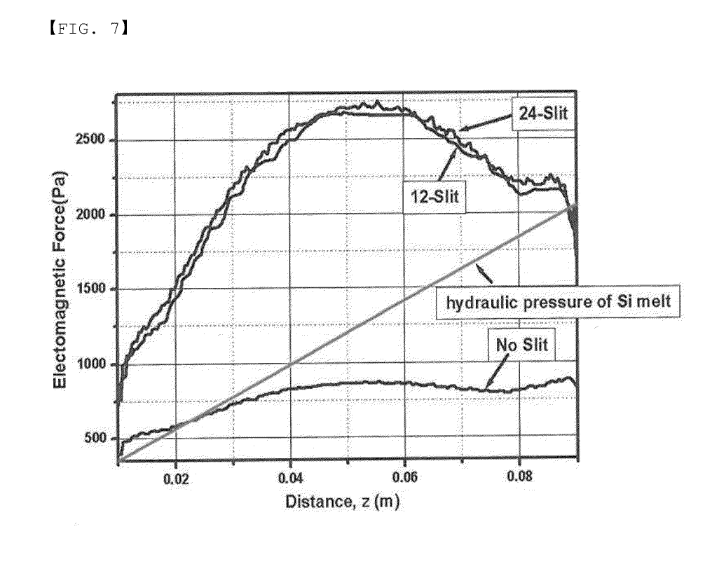

FIG. 7 is a graph depicting hydrostatic pressure and electromagnetic pressure acting on a silicon melt in the vertical direction within the graphite crucible according to the embodiment of the present invention.

It can be seen from FIG. 7 that the electromagnetic pressure acting on a silicon melt is lower than the hydrostatic pressure when the graphite crucible has no slit.

In this case, it is substantially impossible to achieve contact-free silicon melting.

On the other hand, in the graphite crucible formed with 12 or 24 slits 310, the electromagnetic pressure acting toward the inner center of the crucible is higher than the hydrostatic pressure which makes the silicon melt spread.

The plurality of slits 310 may be vertically formed from the upper part of the crucible to a lower surface 324 thereof. Alternatively, since an inner bottom surface 323 and the lower surface 324 of the crucible also are filled with graphite, the plurality of slits 310 may be formed from the upper part of the crucible to the inner bottom surface 323 of the crucible.

In order to allow the electromagnetic force to prevent a silicon melt from contacting the inner wall 322 of the crucible, there is a need to allow the electromagnetic force to act toward the inner center of the crucible. For this purpose, the plural slits 310 may be uniformly arranged and separated at constant intervals from each other such that segments divided by the slits 310 may have the same size.

Further, in order to allow the electromagnetic force to act toward the inner center of the crucible, the plurality of vertical slits 310 may be radially (that is, in the direction of the center) formed in the crucible.

In the cylindrical crucible structure, the electromagnetic force may act toward the inner center of the cylindrical crucible when two or more vertical slits are formed in the crucible. Thus, the number of plural slits 310 can be arbitrarily determined. However, if an excessively small number of slits is formed in the crucible, the electromagnetic force cannot sufficiently act toward the inner center of the crucible, thereby allowing the silicon melt to contact the inner wall 322.

On the other hand, if an excessively large number of slits are formed in the crucible, indirect silicon melting can be retarded due to heat from the graphite crucible, irrespective of sufficient action of the electromagnetic force toward the inner center of the crucible. Thus, the number of vertical slits 310 may be determined in consideration of both indirect silicon melting and non-contact with graphite, and the plural slits may be symmetrically arranged in the radial direction.

For efficient electromagnetic induction melting, the crucible may be formed with at least 12 slits 310, and the number of slits may be increased along with an increase of an inner diameter of the crucible. Here, when the crucible has an inner diameter of 50 mm or more, the crucible may be formed with at least 24 slits.

Although the width of each vertical slit 310 can also be arbitrarily determined, the width of each slit 310 may be determined in the range of 0.1-3 mm in consideration of intensity of the electromagnetic force acting within the crucible and an indirect heating degree obtained by the slits.

Next, the present invention will be described in more detail with reference to inventive and comparative examples.

Numerical analysis and an electromagnetic induction melting test were performed using graphite crucibles having slits, as shown in FIGS. 3 and 4, and a typical crucible having no slit. In the test, electromagnetic forces acting toward the center of silicon melt were calculated while monitoring a contact state of the silicon melt.

### Examples 1 and 2

Graphite crucibles each having a height of 9 mm, an inner diameter of 60 mm and an outer diameter of 80 mm were prepared. Here, one graphite crucible had 12 slits (Example 1) and the other had 24 slits (Example 2), each of which had a slit width of 1 mm and was formed to the bottom of the crucible. Each of the graphite crucibles had a graphite density of 1.75 or more. A cold induction coil having a diameter of 8 mm was turned 8 times around each graphite crucible to have an inner diameter of 100 mm, an outer diameter of 1200 mm, and a separation of 1-2 mm between turns of the induction coil. Alternating power having a frequency of 6-10 kHz was applied up to 20 kW to the coil.

After filling the crucible with a silicon chunk having a purity of 99.5% and a size of 1-10 mm, a base pressure of 10⁻³-10⁻⁵ Torr was created in the crucible, which in turn was filled with Ar. Then, a test was performed by gradually increasing the alternating power at a working pressure of several Torr. In the test, melting behavior was observed while measuring a slit temperature, a bottom temperature and a silicon temperature in each crucible.

### Test Results

For Example 1 having 12 slits, the melting test was performed after filling the graphite crucible with the silicon chunk. As the alternating power was increased, the temperature near the bottom of the crucible was increased at first and there was a temperature difference of about 100° C. between the upper side of the slits and the bottom. When a power of 15 kW or more was supplied, the silicon chunk started melting and the melted silicon was agitated upwardly.

Although a contact-free state between the inner wall of the crucible and the silicon could not be confirmed with the naked eye, there was no flow of the silicon melt through the slits. Further, cooled silicon and the inner wall of the graphite crucible showed that there was no reaction between the silicon melt and graphite.

For Example 2 having 24 slits symmetrically arranged thereon, the same test was performed. As in Example 1, it was found that the temperature near the bottom of the crucible was increased at first and there was a temperature difference of up to 300° C. between the upper side of the slits and the bottom.

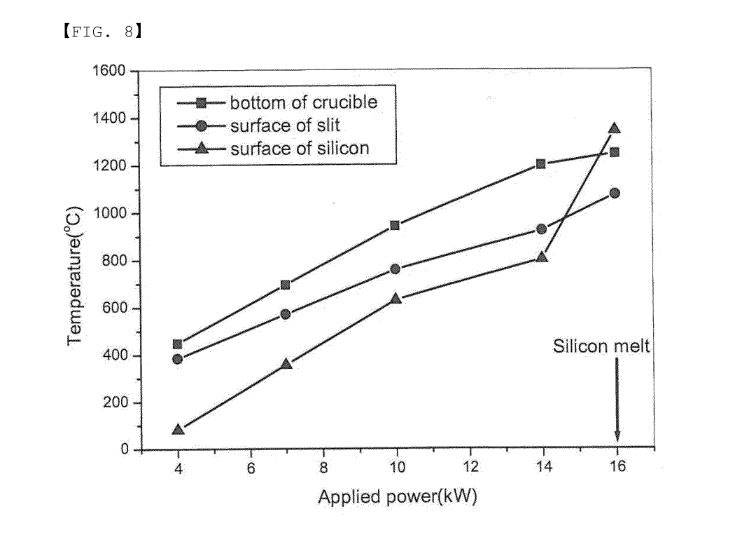

FIG. 8 is a graph depicting temperatures of the crucible bottom, the upper side of the slits, and the upper surface of silicon according to power applied to the induction coil in the examples. When a power of 15 kW or less was applied to the coil, the upper side temperature of the slits was not increased as much as the bottom temperature.

However, when a power of 15 kW or more was applied, the temperature of the silicon was rapidly increased. In other words, silicon started melting near 15 kW and the silicon melt was then moved upward in the crucible by an electromagnetic force which deeply invaded the silicon melt. Then, a silicon melt forming rate was rapidly increased, thereby allowing indirect melting to start.

When a power of 16 kW was applied, the silicon chunk was completely melted and formed a column on the center of the crucible without contacting the inner wall of the crucible.

Here, it should be noted that the temperature of the silicon melt is higher than that of the graphite crucible. This phenomenon cannot be observed by an indirect heating manner of the conventional graphite crucible, and proves that the temperature of the silicon melt was increased due to direct heating by the intensive electromagnetic force invading the silicon melt in the crucible.

### Comparative Example

A graphite crucible of Comparative Example had the same size as Examples 1 and 2, but was not formed with slits. In silicon melting with the graphite crucible of Comparative Example, melting behavior was observed while measuring a slit temperature, a bottom temperature and a silicon temperature according to power applied to an induction coil wound around the crucible. As the applied power was increased, the temperature of the graphite crucible was increased and there was substantially no temperature difference between the outer wall and the bottom of the crucible.

As the silicon chunk started melting, a silicon melt was moved downward and finally contacted an inner wall of the crucible. This is because most of the magnetic field created from the induction coil was absorbed by graphite and failed to effectively invade the silicon melt.

Table 1 shows a ratio of crucible heating value and a ratio of silicon heating value when melting silicon through electromagnetic induction with the conventional graphite crucible having no slit (Comparative Example), the graphite crucible having 12 slits (Example 1), and the graphite crucible having 24 slits (Example 2).

TABLE 1

| | Ratio of heating value by | Ratio of heating value |
|---|---|---|
| Number of | crucible direct induction | by silicon indirect |
| slits | (%) | induction (%) |
| 0 | 92.13 | 7.87 |
| 12 | 64.15 | 35.85 |
| 24 | 53.84 | 46.16 |

In the conventional graphite crucible having no slit (Comparative Example), about 92% of a total heating value was provided by direct induction of graphite. On the other hand, in the graphite crucibles of the inventive examples having plural slits, a ratio of heating value by silicon indirect induction was comparatively high. Specifically, in the graphite crucible having 12 slits (Example 1), about 36% of a total heating value was provided by indirect induction of silicon, and, in the graphite crucible having 24 slits (Example 2), about 46% of a total heating value was provided by indirect induction of silicon.

Therefore, it can be understood from Table 1 that the plural slits in the graphite crucible improve indirect melting efficiency as in the examples.

Table 2 lists amounts of metallic impurities in silicon when melting and refining a silicon raw material containing metallic impurities in the graphite crucible of Example 2.

TABLE 2

| Impurity element | | Al | Fe | Ca | Ti | Mn | Cr | Mg | Zr |
|---|---|---|---|---|---|---|---|---|---|
| Input amount | | 446.4 | 831.1 | 148.8 | 85.9 | 158.5 | 30.3 | <10 | <10 |
| Example 2 | Center | 17.8 | 5.19 | 49.7 | <10 | <10 | <10 | <10 | <10 |
| | Upper | 32.9 | 50.9 | 17.8 | <10 | <10 | <10 | <10 | <10 |
| | surface | | | | | | | | |

In Table 2, it can be seen that the amounts (unit: ppm) of metallic impurities, such as Al, Fe, Ca, Ti, Mn and the like were rapidly decreased in the center and on the upper surface of the crucible after induction melting, compared with the input amount of the impurities.

According to this result, it can be understood that during contact-free silicon melting, an agitation phenomenon was created by electromagnetic induction and caused movement of the impurities towards the surface of the silicon melt to allow vacuum volatile refining thereon. Further, since the silicon melt underwent induction melting without contacting the inner wall of the crucible, the silicon melt has an increased surface area, which improves refining efficiency.

Next, a process of melting silicon in the graphite crucible 300 according to the embodiment will be described.

When an electric current is applied to the induction coil 301 wound around the outer wall 321 of the graphite crucible, the crucible undergoes induction heating. Then, a silicon raw material charged into the crucible is indirectly melted on the bottom of the crucible by heat from the induction-heated crucible, and forms a silicon melt of about 1,400-1,500° C. after a predetermined duration.

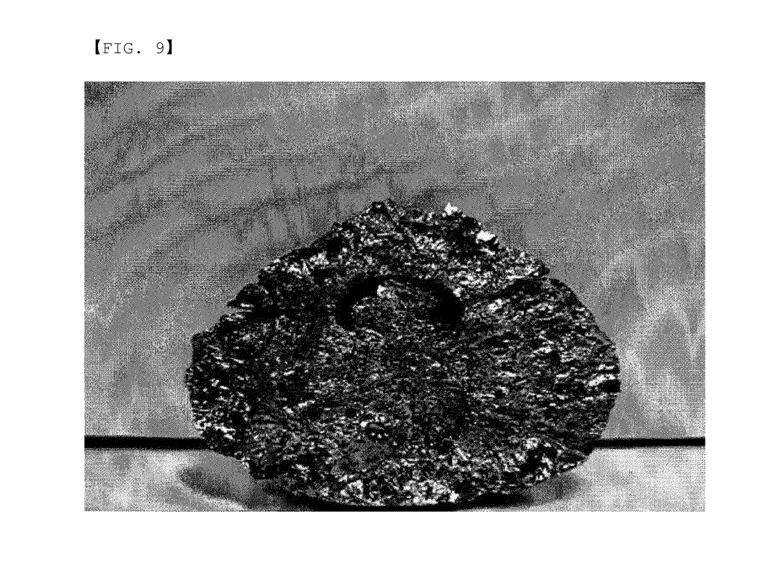

Since silicon exhibits as high electric conductivity as metals at or above the melting point thereof, a silicon melt formed by indirect melting moves upward during induction melting, whereby agitation of the silicon melt occurs. Further, the silicon melt is subjected to direct electromagnetic induction melting without contacting the inner wall 322 of the crucible by the electromagnetic force acting toward the inner center of the crucible. The completely molten silicon does not contact the inner wall 322 of the crucible, and continuous agitation occurs in the silicon melt to force the impurities to move to the surface of the silicon melt. As a result, highly pure silicon can be obtained as shown in FIG. 9.

Since the silicon melt can contact the bottom surface 323 of the crucible, there is a need for preventing the silicon melt from contacting graphite in the inner bottom surface 323 of the crucible. For this purpose, the bottom surface 323 of the crucible may be coated with silicon carbide (SiC) or silicon nitride (Si3N.). Alternatively, a dummy bar formed of silicon carbide (SiC) or silicon nitride (Si3N.) may be placed in advance on the inner bottom surface 323 of the crucible before the silicon raw material is charged into the crucible.

Silicon melting is performed by electromagnetic induction melting, and more particularly by a combination of indirect melting and direct melting as follows.

A silicon raw material charged into the crucible through the open upper part of the crucible is indirectly melted to form a silicon melt by heat from the crucible, which is subjected to induction heating by an electric current flowing in the induction coil 301. Then, the silicon melt is subjected to induction melting without contacting the inner wall 322 of the crucible by the electromagnetic force which is created by the current flowing in the induction coil 301 and acts toward the inner center of the crucible.

Here, since the formation of the silicon melt from the silicon raw material is achieved by heat from the graphite crucible, it can be referred to as indirect melting, and induction melting of the silicon melt without contacting the inner wall 322 of the crucible can be referred to as direct melting.

An apparatus for melting and refining silicon according to an embodiment of the present invention employs a graphite crucible according to an embodiment of the present invention. Therefore, the apparatus can be fabricated at low costs and prevent contamination of silicon and the crucible by achieving contact-free melting. Further, since indirect melting is performed by heat from the graphite crucible at an initial melting stage, there is no need for an additional heat source.

Furthermore, since the crucible is formed of a graphite material, there is no problem of heat loss.

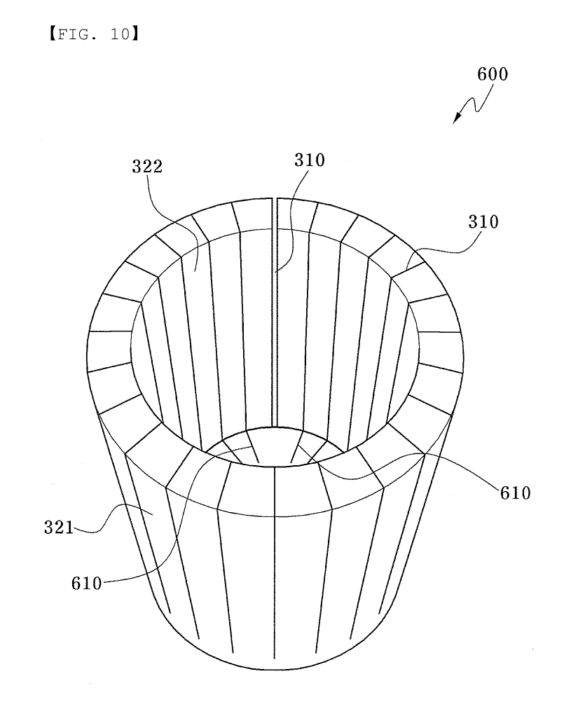

FIG. 10 is a perspective view of a graphite crucible for electromagnetic induction-based silicon melting according to another embodiment of the present invention.

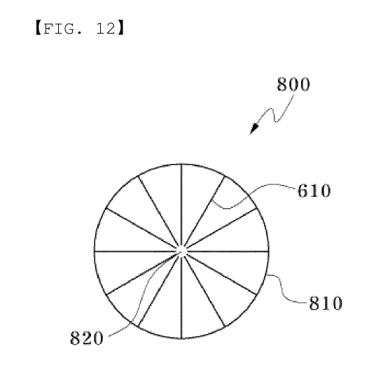

Referring to FIG. 10, the graphite crucible 600 according to this embodiment has a plurality of first slits 310 vertically formed through an inner wall 322 and the outer wall 321 of the crucible, and a plurality of second slits 610 vertically formed from an edge 810 of a bottom 800 (see FIG. 12) of the crucible toward a center 820 of the bottom.

The second plural slits 610 formed on the bottom 800 of the crucible serve to distribute an eddy current which gathers from the first plural slits 310 on the wall of the crucible to the bottom. Here, since the eddy current created by an external electromagnetic field flows on the inner wall 322 and the inner bottom 323 of the crucible, the second plural slits 610 can prevent the lower silicon melt from contacting the bottom surface even when the bottom surface is not completely cut to form the second slits as in the outer wall 321.

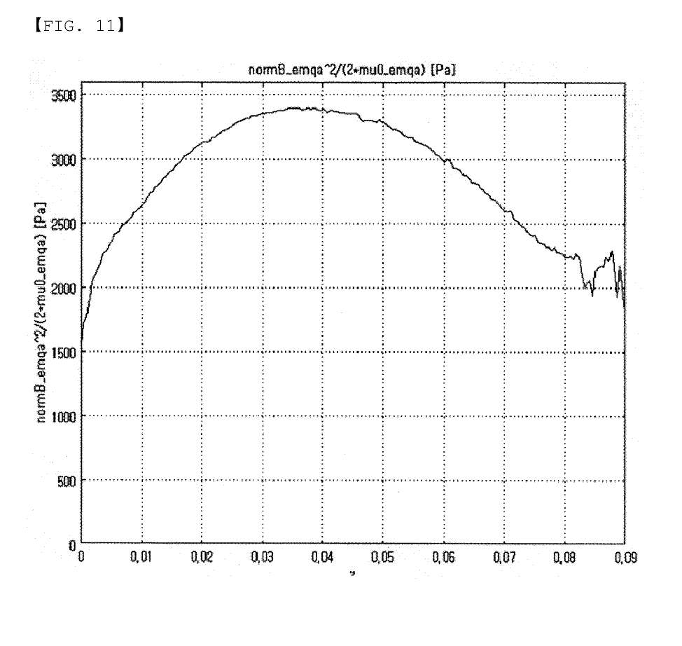

FIG. 11 is a graph depicting a result of numerical analysis on electromagnetic pressure acting on silicon melt in a graphite crucible including second slits on the bottom thereof according to an example of the present invention. It can be seen from FIG. 11 that the second slits 610 on the bottom 800 of the crucible provides a sufficiently higher electromagnetic force than the hydrostatic pressure of the silicon melt as in the crucible having no second slit on the bottom, even when the bottom surface is not completely cut to form the second slits as in the outer wall 321.

Here, as shown in FIG. 12, all of the second slits 610 are disconnected from each other on the center 820 of the bottom, where an imaginary cross point of the second slits 610 is present, to prevent eddy current from concentrating on the center. Such a disconnected part on the center 820 of the bottom prevents concentration of the eddy current, thereby preventing rapid temperature increase on the center of the bottom.

FIG. 12 shows an example of the second slits formed on the bottom of the graphite crucible shown in FIG. 10. Here, the bottom 800 of the crucible has a disc shape, and an upper surface of the bottom constitutes the inner bottom surface 323 of the crucible and a lower surface thereof constitutes a lower surface 324 of the crucible.

Referring to FIG. 12, the second plural slits 610 are formed from the edge 810 of the bottom 800 toward the center 820 thereof where the second plural slits 610 are necessarily disconnected from each other. Like the first slits 310, the second slits 610 may be separated at constant intervals from each other. In some cases, some or all of the first slits 310 may be connected to some or all of the second slits 610.

Next, a process of melting silicon in the graphite crucible 600 according to this embodiment will be described.

When an electric current is applied to the induction coil 301 wound around the outer wall 321 of the graphite crucible, the crucible undergoes induction heating. Then, a silicon raw material charged into the crucible is indirectly melted on the bottom of the crucible by heat from the induction-heated crucible, and forms a silicon melt of about 1,400-1,500° C. after a predetermined duration.

Since silicon exhibits as high electric conductivity as metals at or above the melting point thereof, the silicon melt formed by indirect melting moves upward during induction melting, whereby agitation of the silicon melt occurs. Further, the silicon melt undergoes direct electromagnetic induction melting without contacting the inner wall 322 of the crucible by the electromagnetic force acting toward the inner center of the crucible. Further, the plurality of second slits 610 are formed from the edge 810 of the bottom 800 toward the center 820 thereof, so that an eddy current is distributed on the bottom surface 323 of the crucible so as not to concentrate on the bottom 800 of the crucible, thereby preventing the silicon melt from contacting the bottom surface 323 of the crucible.

The completely molten silicon does not contact the inner wall 322 of the crucible, and continuous agitation occurs in the molten silicon to force impurities to move to the surface of the molten silicon. As a result, highly pure silicon can be obtained.

The graphite crucible for electromagnetic induction-based silicon melting according to the present invention may be applied to an apparatus for melting and refining silicon. In this case, the apparatus includes the graphite crucible 600 shown in FIG. 10 and an induction coil 301 wound around the outer wall 321 of the crucible.

Melting and refining of silicon are performed by electromagnetic induction melting, and more particularly by a combination of indirect melting and direct melting as follows.

In melting and refining of silicon, a silicon raw material charged into the crucible through the open upper part of the crucible is indirectly melted to form a silicon melt by heat from the crucible, which undergoes induction heating by an electric current flowing in the induction coil 301. Then, the silicon melt is subjected to induction melting without contacting the inner wall 322 of the crucible by the electromagnetic force which is created by the current flowing in the induction coil 301 and acts toward the inner center of the crucible. Further, the second plural slits 610 formed on the bottom 800 of the crucible serve to distribute eddy current concentrating on the bottom 800, thereby preventing the silicon melt from contacting the bottom surface 323 of the crucible.

Here, since the formation of the silicon melt from the silicon raw material is achieved by heat from the graphite crucible, it can be referred to as indirect melting, and induction melting of the silicon melt without contacting the inner wall 322 of the crucible can be referred to as direct melting.

The apparatus for melting and refining silicon according to the embodiment of the invention can be fabricated at low costs and prevent contamination of silicon or the crucible by achieving contact-free melting on the inner wall 322 and the inner bottom surface 323 of the crucible. Further, since indirect melting is performed by heat from the graphite crucible at an initial melting stage, there is no need for an additional heat source. Furthermore, since the crucible is formed of a graphite material, there is no problem of heat loss.

Although some embodiments have been provided to illustrate the present invention, it will be apparent to a person skilled in the art that various modifications or changes can be made without departing from the spirit and scope of the present invention. Therefore, the scope of the present invention should be limited only by the following claims.

What is claimed is:

1. A graphite crucible induction-based silicon melting, the graphite crucible comprising:
a cylindrical body having a plurality of slits which is formed through an outer wall and an inner wall of the cylindrical body; and
a bottom part connected with an edge of the cylindrical body to seal an end of the cylindrical body.

2. The graphite crucible according to claim 1, wherein the plurality of slits are formed from an upper side of the cylindrical body to a bottom side of the cylindrical body and separated at constant intervals from each other.

3. The graphite crucible according to claim 1, wherein an inner surface of the bottom part is coated with at least one of SiC and Si₃N₄.

4. The graphite crucible according to claim 1, wherein the bottom part comprises a plurality of auxiliary slits which are formed from an edge portion of the bottom part toward a center portion of the bottom part.

5. The graphite crucible according to claim 4, wherein the plurality of auxiliary slits are not formed at a center of the bottom part so that the plurality of auxiliary slits are disconnected each other on the bottom part.

6. The graphite crucible according to claim 4, wherein the plurality of auxiliary slits are correspondingly connected to the plurality of slits.

7. An apparatus for melting and refining silicon with a crucible for electromagnetic induction-based silicon melting, the apparatus comprising:
a graphite crucible charged with a silicon raw material; and
an induction coil surrounding the graphite crucible,
wherein the graphite crucible includes a plurality of slits formed through an outer wall and an inner wall thereof so that a silicon melt which the silicon raw material is melted by undergoing induction heating of the induction coil does not react with an inner wall of the graphite crucible.

8. The apparatus according to claim 7, wherein the graphite crucible comprises a cylindrical body having a plurality of slits which is formed through an outer wall and an inner wall of the cylindrical body; and a bottom part connected with an edge of the cylindrical body to seal an end of the cylindrical body.

9. The apparatus according to claim 8, wherein the plurality of slits are formed from an upper side of the cylindrical body to a bottom side of the cylindrical body and separated at constant intervals from each other.

10. The apparatus according to claim 8, wherein an inner surface of the bottom part is coated with at least one of SiC and Si₃N₄.

11. The apparatus according to claim 8, wherein the bottom part comprises a plurality of auxiliary slits which are formed from an edge portion of the bottom part toward a center portion of the bottom part.

12. The apparatus according to claim 11, wherein the plurality of auxiliary slits are not formed at a center of the bottom part so that the plurality of auxiliary slits are disconnected each other on the bottom part.

13. The apparatus according to claim 11, wherein the plurality of auxiliary slits are correspondingly connected to the plurality of slits.

14. The apparatus according to claim 11, wherein the plurality of auxiliary slits distribute an eddy current which is created by an electromagnetic force of the induction coil.

15. An apparatus for melting and refining silicon with a crucible for electromagnetic induction-based silicon melting, the apparatus comprising:
a graphite crucible charged with a silicon raw material; and
an induction coil surrounding the graphite crucible,
wherein the graphite crucible includes a plurality of slits formed through an outer wall and an inner wall thereof so that an electromagnetic force which is created by the induction coil effects toward an inner portion of the graphite crucible.

16. The apparatus according to claim 7, wherein the graphite crucible comprises a cylindrical body having a plurality of slits which is formed through an outer wall and an inner wall of the cylindrical body; and a bottom part connected with an edge of the cylindrical body to seal an end of the cylindrical body.

17. The apparatus according to claim 16, wherein the plurality of slits are formed from an upper side of the cylindrical body to a bottom side of the cylindrical body and separated at constant intervals from each other.

18. The apparatus according to claim 16, wherein the bottom part comprises a plurality of auxiliary slits which are formed from an edge portion of the bottom part toward a center portion of the bottom part.

19. The apparatus according to claim 16, wherein the plurality of auxiliary slits are not formed at a center of the bottom part so that the plurality of auxiliary slits are disconnected each other on the bottom part.

20. The apparatus according to claim 11, wherein the plurality of auxiliary slits distribute an eddy current which is created by an electromagnetic force of the induction coil.
